(19) United States
(12) Patent Application Publication
(10) Pub. No.: US 2011/0193976 A1
(43) Pub. Date: Aug. 11, 2011

(54) SYSTEM AND METHOD FOR CAPTURING IMAGES

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/756,967

(22) Filed: Apr. 8, 2010

(30) Foreign Application Priority Data
Feb. 5, 2010 (CN) 201010301281.6

(51) Int. Cl. H04N 5/228

(52) U.S. Cl. 348/208.2; 348/E05.031

(57) ABSTRACT

A system and method for capturing images acquires vibration data of a vehicle by an acceleration sensor, and transfers the vibration data to a digital video recorder (DVR) device. The system and method further adjusts a position of a lens of an image obtaining device according to the vibration data by the DVR device, controls the lens to capture images by the image obtaining device, and stores the captured images in a storage device of the DVR device.

### BACKGROUND

1. Technical Field

Embodiments of the present disclosure relate to image capture technology, and particularly to a system and a method for capturing images using an acceleration sensor.

2. Description of Related Art

Currently, digital video recorder (DVR) devices are installed in vehicles to obtain images captured by an image obtaining device. However, if vibration of the vehicle occurs when the vehicle is moving, the images captured by the image obtaining device may be fuzzy. The fuzzy images are difficult to process by the DVR device. Therefore, what is desired is an efficient system for capturing images that can overcome the afore-mentioned limitation.

### BRIEF DESCRIPTION OF THE DRAWINGS

FIG. 1 is a block diagram of one embodiment of a system for capturing images.

FIG. 2 is a schematic diagram of one embodiment of a system for adjusting a position of a lens of an image obtaining device used by the system of FIG. 1, using a dual-axis gyro.

FIG. 3 is a flowchart of one embodiment of a method for capturing images using the system of FIG. 2.

### DETAILED DESCRIPTION

All of the processes described below may be embodied in, and fully automated via, functional code modules executed by one or more general purpose computers or processors. The code modules may be stored in any type of readable medium or other storage device. Some or all of the methods may alternatively be embodied in specialized hardware. Depending on the embodiment, the readable medium may be a hard disk drive, a compact disc, a digital video disc, or a tape drive.

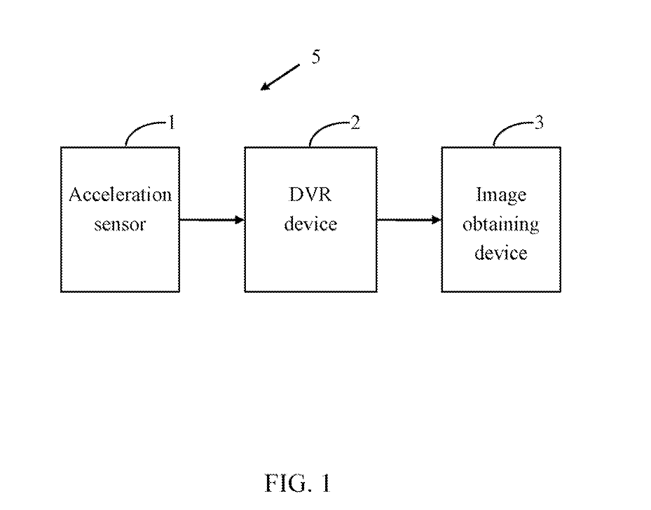

FIG. 1 is a block diagram of one embodiment of a system 5 for capturing images. In one embodiment, the system 5 includes an acceleration sensor 1, a digital video recorder (DVR) device 2, and an image obtaining device 3. The DVR device 2 is electronically connected to the acceleration sensor 1 and the image obtaining device 3.

In one embodiment, the system 5 is installed in a vehicle to obtain images when the vehicle is moving. The acceleration sensor 1 may be used to acquire vibration data of the vehicle, and transfer the vibration data to the DVR device 2. Then the DVR device 2 adjusts a position of a lens of the image obtaining device 3 according to the vibration data of the vehicle. Detailed descriptions will be given in the following paragraphs.

In one embodiment, the acceleration sensor 1 may be, but are not limited to, a dual-axis acceleration sensor, a three-axis acceleration sensor, a dual-axis gyro, or a three-axis gyro. The image obtaining device 3 may be a speed dome camera or pan/tilt/zoom (PTZ) camera.

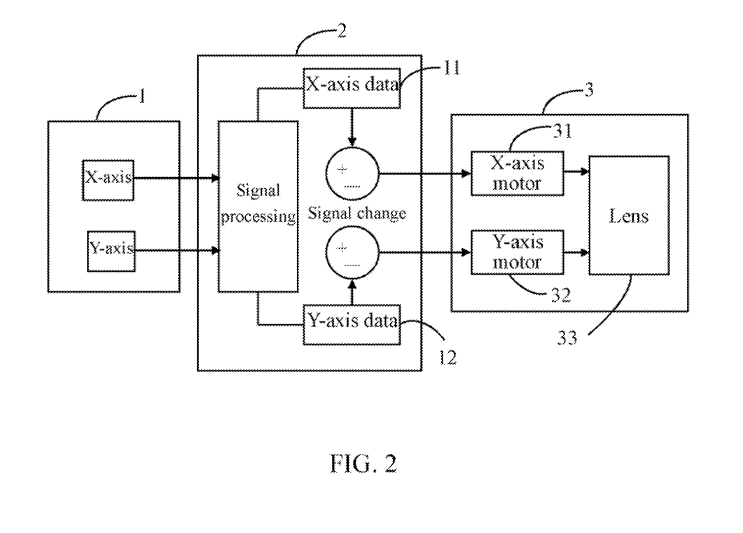

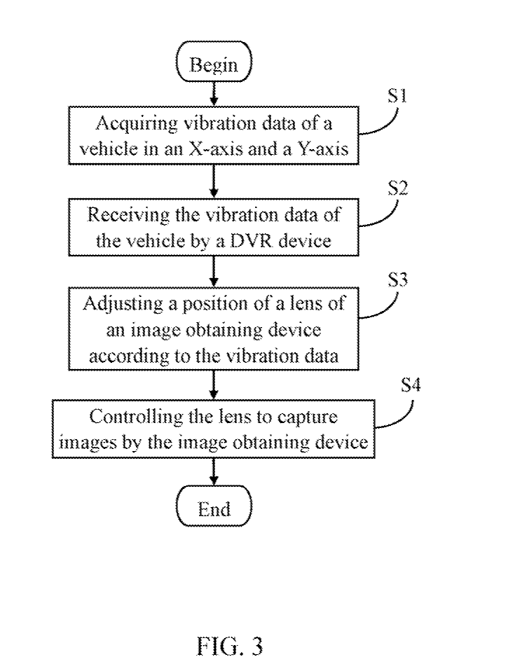

FIG. 3 is a flowchart of one embodiment of a method for capturing images. The following description will take a dual-axis gyro as an example (referring to FIG. 2).

In block S1, the acceleration sensor 1 acquires vibration data of the vehicle in an X-axis (e.g., X-axis data 11 as shown in FIG. 2) and vibration data of the vehicle in a Y-axis (e.g., Y-axis data 12 as shown in FIG. 2). Then the acceleration sensor 1 transfers the vibration data of the vehicle in the X-axis and the Y-axis to the DVR device 2. In one embodiment, the vibration data includes a vibration direction and a vibration angle of the vehicle in the X-axis, and a vibration direction and a vibration angle of the vehicle in the Y-axis.

In block S2, the DVR device 2 receives the vibration data of the vehicle.

In block S3, the DVR device 2 adjusts a position of a lens 33 of the image obtaining device 3 according to the vibration data, so as to obtain stable images. Provided is a detailed description as follows.

In one embodiment, the DVR device 2 controls an X-axis motor 31 of the image obtaining device 3 to move the lens 33 rightward according to the vibration angle of the vehicle in the X-axis, if the vibration direction of the vehicle in the X-axis is left (e.g., a signal change in the X-axis is negative).

The DVR device 2 controls the X-axis motor 31 of the image obtaining device 3 to move the lens 33 leftward according to the vibration angle of the vehicle in the X-axis, if the vibration direction of the vehicle in the X-axis is right (e.g., the signal change in the X-axis is positive).

The DVR device 2 controls a Y-axis motor 32 of the image obtaining device 3 to move the lens 33 downward according to the vibration angle of the vehicle in the Y-axis, if the vibration direction of the vehicle in the Y-axis is up (e.g., a signal change in the Y-axis is positive).

The DVR device 2 controls the Y-axis motor 32 of the image obtaining device 3 to move the lens 33 upward according to the vibration angle of the vehicle in the Y-axis, if the vibration direction of the vehicle in the Y-axis is down (e.g., the signal change in the Y-axis is negative).

In block S4, the image obtaining device 3 controls the lens 33 to capture images, and stores the captured images in a storage device (e.g., a hard disk) of the DVR device 2.

In other embodiment, the system 5 may be applied in a robot or a shockproof camera to obtain stable images.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for capturing an image using a system, the system comprising an acceleration sensor, a digital video recorder (DVR) device, and an image obtaining device, the method comprising:
acquiring vibration data of a vehicle in an X-axis and a Y-axis by the acceleration sensor, and transferring the vibration data to the DVR device;
adjusting a position of a lens of the image obtaining device according to the vibration data by the DVR device; and
controlling the lens to capture images by the image obtaining device, and storing the captured images in a storage device of the DVR device.

2. The method according to claim 1, wherein the acceleration sensor is selected from the group consisting of a dual-axis acceleration sensor, a three-axis acceleration sensor, a dual-axis gyro, and a three-axis gyro.

3. The method according to claim 1, wherein the image obtaining device is a speed dome camera or a pan/tilt/zoom (PTZ) camera.

4. The method according to claim 1, wherein the vibration data comprises a vibration direction and a vibration angle of the vehicle in the X-axis, and a vibration direction and a vibration angle of the vehicle in the Y-axis.

5. The method according to claim 4, wherein the step of adjusting a position of a lens of the image obtaining device according to the vibration data by the DVR device comprises:
controlling an X-axis motor of the image obtaining device to move the lens rightward according to the vibration angle of the vehicle in the X-axis if the vibration direction of the vehicle in the X-axis is left;
controlling the X-axis motor of the image obtaining device to move the lens leftward according to the vibration angle of the vehicle in the X-axis if the vibration direction of the vehicle in the X-axis is right;
controlling a Y-axis motor of the image obtaining device to move the lens downward according to the vibration angle of the vehicle in the Y-axis if the vibration direction of the vehicle in the Y-axis is up; or
controlling the Y-axis motor of the image obtaining device to move the lens upward according to the vibration angle of the vehicle in the Y-axis if the vibration direction of the vehicle in the Y-axis is down.

6. A system for capturing images, the system comprising an acceleration sensor, a digital video recorder (DVR) device, and an image obtaining device, wherein:
the acceleration sensor is operable to acquire vibration data of a vehicle in an X-axis and a Y-axis, and transfer the vibration data to the DVR device;
the DVR device is operable to receive the vibration data, and adjust a position of a lens of the image obtaining device according to the vibration data; and
the image obtaining device is operable to control the lens to capture images, and store the captured images in a storage device of the DVR device.

7. The system according to claim 6, wherein the acceleration sensor is selected from the group consisting of a dual-axis acceleration sensor, a three-axis acceleration sensor, a dual-axis gyro, and a three-axis gyro.

8. The system according to claim 6, wherein the image obtaining device is a speed dome camera or a pan/tilt/zoom (PTZ) camera.

9. The system according to claim 6, wherein the vibration data comprises a vibration direction and a vibration angle of the vehicle in the X-axis, and a vibration direction and a vibration angle of the vehicle in the Y-axis.

10. The system according to claim 9, wherein the DVR device adjusts a position of a lens of the image obtaining device according to the vibration data by:
controlling an X-axis motor of the image obtaining device to move the lens rightward according to the vibration angle of the vehicle in the X-axis if the vibration direction of the vehicle in the X-axis is left;
controlling the X-axis motor of the image obtaining device to move the lens leftward according to the vibration angle of the vehicle in the X-axis if the vibration direction of the vehicle in the X-axis is right;
controlling a Y-axis motor of the image obtaining device to move the lens downward according to the vibration angle of the vehicle in the Y-axis if the vibration direction of the vehicle in the Y-axis is up; or
controlling the Y-axis motor of the image obtaining device to move the lens upward according to the vibration angle of the vehicle in the Y-axis if the vibration direction of the vehicle in the Y-axis is down.
